(19) United States
(12) Patent Application Publication
(10) Pub. No.: US 2016/0277504 A1
(43) Pub. Date: Sep. 22, 2016

(54) LIN NETWORK

(71) Applicant: Röchling Automotive SE & Co. KG, Mannheim (DE)

(72) Inventors: Domenico SOLAZZO, Worms (DE); Carsten FUNK, Immesheim (DE)

(21) Appl. No.: 15/064,851

(22) Filed: Mar. 9, 2016

(30) Foreign Application Priority Data
Mar. 18, 2015 (DE) 10 2015 204 924.8

(51) Int. Cl. H04L 29/08; B60R 16/023

(52) U.S. Cl. CPC H04L 67/12; B60R 16/023

(57) ABSTRACT

A LIN network having a plurality of communications units linked for communicating to one another via a communications path, having a master communications unit and at least one slave communications unit, the LIN network having a LIN-LIN interface unit which is arranged to provide a communication link between LIN network and a LIN sub-network according to the LIN standard.

The present invention relates to a LIN network comprising a plurality of communications units linked for communicating to one another via a communications path, having a master communications unit and at least one slave communications unit.

### BACKGROUND OF THE INVENTION

LIN (Local Interconnect Network) is a standard which is commonly applied where the bandwidths and the data transfer rates of high-performance networks, for example, of CAN networks (CAN=Controller Area Network), are not required, for example, when networking actuators and sensors. In contrast to CAN networks, in which data are differentially exchanged via dual or multi-wire data transmission lines, the LIN network only uses single-wire data transmission lines, which simplifies the architecture of such networks vis-à-vis CAN networks. In a LIN network, for example, the electrical potential of a housing, receiving the linked communications units and at least partially manufactured from conductive material, can be used as reference potential.

The temporal sequence in which data are transferred in a LIN network is specified by the master communications unit, the slave communication units only transferring data when prompted by the master communications unit. The data transfer within the LIN network is carried out according to a communications protocol in accordance with the LIN standard.

A LIN network defined at the outset is, for example, known from the printed publication DE 10 2007 006 296 A1, in which a plurality of weight sensors, configured as slave communications units and installed in a vehicle seat, and an airbag control device serving as the master communications unit are networked. The signals issued by the weight sensors, representing the weight of an occupant situated in the vehicle seat, serve as a basis for the airbag control device to control the airbag.

In generic LIN networks provided by original equipment manufacturers, the limited number of slave communications units and the lacking possibility to expand such a network by more than one additional slave communications unit in accordance with the LIN standard are disadvantageous.

### SUMMARY OF THE INVENTION

It is an object of the present invention to specify a LIN network which may be expanded in a simple manner by additional communications units in accordance with the LIN standard.

According to the present invention, this object and others are achieved by the LIN network of the art mentioned at the outset, comprising a LIN-LIN interface unit arranged to provide a communication link between the LIN network and a LIN sub-network according to the LIN standard.

In a LIN network according to the present invention, the option to configure a LIN network provided by original equipment manufacturers is used to expand this network by one interface unit, to which, in turn, a plurality of further communications units are linkable in the LIN sub-network. Since the LIN-LIN interface unit provides a communication link between the LIN network and the LIN sub-network according to the LIN standard, it may be made use of the standardized LIN communications protocol so that individual adaptive measures between the LIN network and the LIN-LIN interface unit are omitted.

For this purpose, it may be provided that the LIN sub-network is also arranged according to the LIN standard because then the previously discussed advantages of the LIN standard can also be beneficial in the LIN sub-network. In this instance, it may particularly be made use of standardized slave communications units, for example, sensors and actuators, for the LIN sub-network.

In order to enable a flexible expansion in a specified LIN network, in a further development of the present invention it may be provide that the LIN-LIN interface is arranged for operating as master communications unit and also as slave communications unit. This configuration has the advantage that only one base LIN-LIN interface unit has to be provided which, as a function of the specific configuration of an existing LIN network, can be used either as master or slave communications unit.

Preferably, the LIN-LIN interface unit is arranged for operating as master communications unit in the LIN sub-network and for operating as slave communications unit in the LIN network. In this instance, the LIN-LIN interface unit as slave communications unit communicates in the LIN network according to the specifications of the respective master communications unit. In its function as master communications unit in the LIN sub-network, said LIN-LIN interface unit specifies on its part the temporal sequence in which the slave communications units send data in the LIN sub-network and, in this manner, it is also able to take into account the specifications of the master communications unit in the LIN network. Thus, this configuration enables an optimal tuning of the communication in the LIN sub-network with the communication in the LIN network.

In order to enable to provide a substantially independent communication of the LIN-LIN interface unit with the LIN network on the one hand and the LIN sub-network on the other hand, the LIN-LIN interface unit preferably comprises a LIN transceiver for communicating with the LIN network as slave communications unit and a LIN transceiver for communicating with the LIN sub-network as master communications unit.

A data exchange of the LIN-LIN interface unit via the LIN transceiver for communicating with the LIN network as slave communications unit and/or via the LIN transceiver for communicating with the LIN sub-network as master communications unit in accordance with the LIN standard can preferably be ensured in that the LIN-LIN interface unit comprises a microcontroller for controlling at least one transceiver from LIN transceivers for communicating with the LIN network as slave communications unit and from LIN transceivers for communicating with the LIN sub-network as master communications unit, preferably for controlling the LIN transceiver for communicating with the LIN network as slave communications unit and also the LIN transceiver for communicating with the LIN sub-network as master communications unit.

Since LIN networks only have a limited bandwidth and data exchange rate, they are often used only for networking subareas of a greater functional unit. In this instance, it may be necessary or advantageous to centrally control a plurality of subareas or all subareas of the functional unit by networking a plurality of LIN networks. For this purpose, it may be advantageous when the LIN network comprises an interface communications unit arranged to provide a communication link between the LIN network and a superordinate network. In such a superordinate network, for example, a plurality of LIN networks may be networked. In order to be able to particularly well tune the communication in the LIN network with the communication in the superordinate network, it is hereby advantageous when the master communications unit is arranged to operate as interface communications unit. Since the master communications unit in a LIN network determines the temporal sequence in which the slave communications units send data, it may, in this configuration, specify the communication of the slave communications units taking into account the communication in the superordinate network.

Since, as previously described, LIN networks only have a limited capacity in regard to bandwidth and data transfer rate, it is advantageous when operating the superordinate network is based on a standard different from the LIN standard. In this way, the LIN networks used in different subareas of a greater functional unit may be integrated into, in contrast to LIN networks, a higher-performance network, for example, a CAN network.

The present invention relates also to a motor vehicle comprising a LIN network according to the present invention. In a motor vehicle, a LIN network according to the present invention may be used to network sensors and actuators in different subareas, for example, in an air damper device. Preferably, the air damper controller is integrated into a LIN sub-network because then the air damper device may first be tested as a separate module independent from the rest of the vehicle electronic and, only after testing has been successfully completed, said air damper controller may be linked via the LIN-LIN interface to a LIN network according to the present invention.

Even though a potential use of a LIN network according to the present invention in a motor vehicle has been described previously, it shall not be excluded that a LIN network according to the present invention may also be used in other areas different from the motor vehicle area, for example, in automation technology or medical technology.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 shows a schematic view of a LIN network according to the present invention; and

FIG. 2 shows a schematic illustration of a LIN-LIN interface unit.

### DESCRIPTION OF PREFERRED EMBODIMENTS

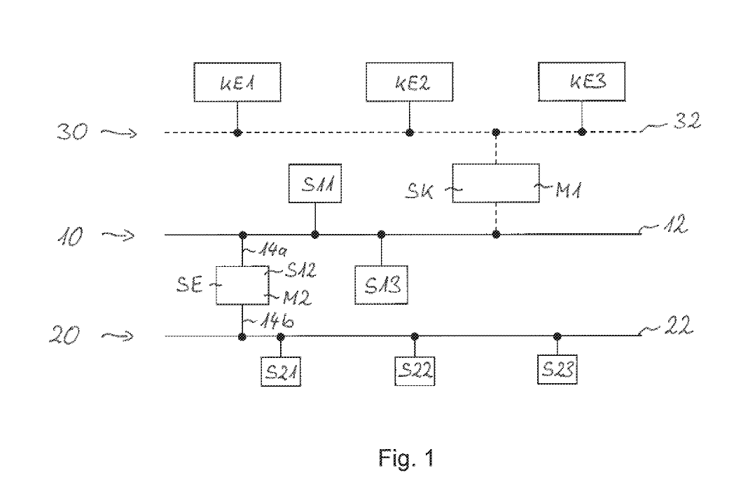

Referring now to the drawing wherein the showings are for the purpose of illustrating preferred and alternative embodiments of the invention only and not for the purpose of limiting the same, FIG. 1 shows a LIN network that is generally referenced by the reference character 10. LIN (Linear Interconnect Network) is a standard which is primarily used when no large bandwidths or high data transfer rates are required. LIN network 10 comprises a master communications unit M1 and at least one slave communications unit. As illustrated in FIG. 1, said LIN network may comprise a plurality of slave communications units S11, S12, S13. Even though here only three slave communications units are illustrated, a number of slave communications units different from three may, of course, also be provided.

Master communications unit M1 and slave communications units S11, S12, S13 are linked for communicating to one another via a communications path 12. Communications path 12 comprises one single-wire data transmission line, the electrical potential of a housing, which receives communications units M1, S11, S12, S13 and is at least partially manufactured from conductive material, can, for example, be used as reference potential. In this way, the architecture of LIN network 10 is simplified compared to a comparatively higher-performance network, for example, a CAN network, in which data are exchanged via multi-wire data transmission lines.

In LIN networks provided by original equipment manufacturers, there is generally the problem that the maximum number of the slave communications units is limited and that it is only possible to expand such a network by only one additional communications unit.

In order to avoid this problem, LIN network 10 comprises a LIN-LIN interface unit SE arranged to provide a communication link between LIN network 10 and a LIN sub-network 20 according to the LIN standard. In doing so, the option to configure a LIN network 10 provided by original equipment manufacturers is used to expand LIN network 10 by one interface unit to which, in turn, a further network may be linked. Thus, this ultimately offers the option to expand LIN network 10 via LIN-LIN interface unit SE by more than one further communications unit.

Since LIN-LIN interface unit SE provides a communication link between LIN network 10 and LIN sub-network 20 according to the LIN standard, the standardized LIN communications protocol may be used so that individual adaptive measures between the LIN network and the LIN-LIN interface unit can be omitted.

Preferably, LIN sub-network 20 is also arranged for operating according to the LIN standard because then standardized communications units may also be used in LIN sub-network 20. As shown in FIG. 1, LIN sub-network 20 may comprise a LIN master sub-communications unit and a plurality of LIN slave sub-communications units S21, S22, S23 which may be linked for communicating with one another via LIN sub-communications path 22.

As shown in FIG. 1, LIN-LIN interface unit SE may, in LIN network 10, be arranged for operating as slave communications unit and, in LIN sub-network 20, for operating as LIN sub-master communications unit M2. Such a LIN-LIN interface unit SE communicates in LIN network 10 according to specifications of master communications unit M1 as slave communications unit and specifies, in its function as LIN slave sub-communications unit M2 in LIN sub-network 20, on its part the temporal sequence in which LIN slave sub-communications units S21, S22, S23 may sent data. In this way, LIN-LIN interface unit SE may also take into account the specifications of master communications unit M1 and, thus, provide an optimal tuning of the communication in LIN sub-network 20 with the communication in LIN network 10.

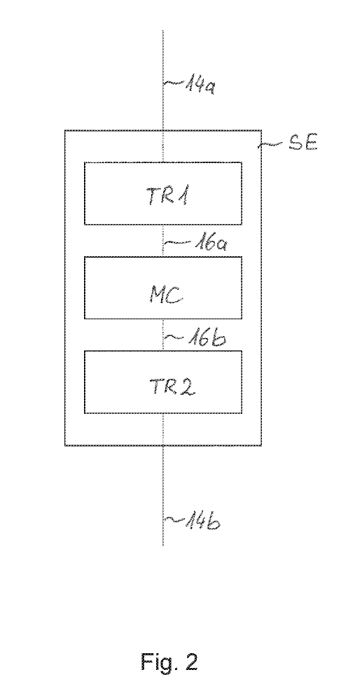

FIG. 2 shows a schematic illustration of the architecture of LIN-LIN interface unit SE. Said LIN-LIN interface unit may comprise a LIN transceiver TR1, providing a communication link via a data line 14a to LIN network 10, and a LIN transceiver TR2, providing a communication link via a data line 14b to LIN sub-network 20. Transceivers TR1 and TR2, both may, when a microcontroller MC is operating, be controlled via a control line 16a or 16b for a data exchange link to LIN network 10 or LIN sub-network 20 according to the LIN standard. In FIG. 2, control lines 16a, 16b running within LIN-LIN interface unit SE and sections of data lines 14a, 14b running within LIN-LIN interface unit SE are shown in a dotted manner.

As shown in FIG. 1, LIN network 10 may furthermore comprise an interface communications unit SK arranged to provide a communication link between LIN network 10 and a superordinate network 30. Superordinate network 30 may also be arranged for operating according to the LIN standard. If, for example, a plurality of LIN networks are, however, to be linked to one another in superordinate network 30, it is advantageous if it is arranged for operating according to a standard different from the LIN standard, for example, to the CAN standard. A CAN network is, particularly in regard to bandwidth and data transfer rate, more powerful than a LIN network and, for this reason, is particularly suitable to link a plurality of functional sub-units, for example, a LIN network, of a greater functional unit to one another.

As shown in FIG. 1, this superordinate network 30 may comprise a plurality of communications units KE1, KE2, KE3, which may be configured as control devices or further networks, for example, LIN networks, and which are linked to one another to exchange data via a data exchange path 32. In the exemplary embodiment shown in FIG. 1, master communications unit M1 is also arranged for operating as interface communications unit SK. In doing so, interface communications unit SK may, in its function as master communications unit M1, specify, by taking into account the communication in superordinate network 30, the temporal sequence in which slave communications units S11, S12, S13 send data in LIN network 10 and, for this reason, tune the communication in LIN network 10 with the communication in superordinate network 30.

Previously described LIN network 10 may be used to network sensors and actuators in different subareas of a motor vehicle, for example, to network sensors and actuators in an air damper device. Within this context it may also be conceivable to implement the control of an air damper device into a LIN sub-network, as this makes it possible to first test the air damper device as a module independent from the motor vehicle and to link it to LIN network 10 via LIN-LIN interface SE only after testing has successfully been completed.

Even though a potential use of LIN network 10 in a motor vehicle has been illustrated previously, it shall not be excluded that the previously described LIN network can also be used in other areas, for example, in automation technology or medical technology.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-10. (canceled)

11. A LIN network comprising a plurality of communications units linked for communicating to one another via a communications path, having a master communications unit and at least one slave communications unit, the LIN network further comprising a LIN-LIN interface unit arranged to provide a communication link between the LIN network and a LIN sub-network according to a LIN standard.

12. The LIN network according to claim 11, wherein the LIN sub-network is arranged for operating according to the LIN standard.

13. The LIN network according to claim 11, wherein the LIN-LIN interface unit is arranged for operating as a master communications unit and also as a slave communications unit.

14. The LIN network according to claim 13, wherein the LIN-LIN interface unit is arranged for operating as the master communications unit in the LIN sub-network and for operating as the slave communications unit in the LIN network.

15. The LIN network according to claim 14, wherein the LIN-LIN interface unit comprises a LIN transceiver for communicating with the LIN network as the slave communications unit and a LIN transceiver for communicating with the LIN sub-network as the master communications unit.

16. The LIN network according to claim 15, wherein the LIN-LIN interface unit comprises a microcontroller for controlling at least one transceiver from the LIN transceiver for communicating with the LIN network as the slave communications unit and from the LIN transceiver for communicating with the LIN sub-network as the master communications unit.

17. The LIN network according to claim 15, wherein the LIN-LIN interface unit comprises a microcontroller for controlling the LIN transceiver for communicating with the LIN network as the slave communications unit and also the LIN transceiver for communicating with the LIN sub-network as the master communications unit.

18. The LIN network according to claim 11, further including an interface communications unit arranged to provide a communication link between the LIN network and a superordinate network.

19. The LIN network according to claim 18, wherein the master communications unit is arranged to operate as the interface communications unit.

20. The LIN network according to claim 18, wherein an operation of the superordinate network is based on a standard different from the LIN standard.

21. The LIN network according to claim 20, wherein the standard for the superordinate network is a CAN standard.

22. A motor vehicle comprising a LIN network according to claim 11.

23. The motor vehicle according to claim 22, wherein an air damper controller is implemented in the LIN sub-network.
